(19) United States
(12) Patent Application Publication
(10) Pub. No.: US 2016/0283844 A1
(43) Pub. Date: Sep. 29, 2016

(54) LOAD PREDICTOR FOR A COOLING SYSTEM

(71) Applicant: Optimum Energy LLC, Seattle, WA (US)

(72) Inventors: Thomas Jones, Seattle, WA (US); Ian Robert Dempster, Seattle, WA (US)

(21) Appl. No.: 14/671,735

(22) Filed: Mar. 27, 2015

(51) Int. Cl. G06N 5/02; G05D 23/13

(52) U.S. Cl. CPC G06N 5/022; G05D 23/1393

(57) ABSTRACT

The present invention includes methods for determining a predicted building heating or cooling load for a future time using historical data points recorded in situ to build analytical models that use predictions of environmental conditions to provide building administrators and systems with an automated prediction of building load over a period of time. In one embodiment, the present invention allows for the automatic creation of a plan of the day by dynamically providing local building systems with a prediction of load from moment to moment that can then be used to make maximally efficient HVAC equipment operation choices. Additionally, this invention provides a method to predict and model building energy usage using a K-nearest neighbors analytical model or a linear regression model.

### FIELD OF THE INVENTION

This invention relates to systems and methods for controlling and scheduling of equipment such as, but not limited to, like chillers or boilers or pumps, in mechanical HVAC systems, through the prediction of building heating or cooling loads using historical load data recorded in situ with various sensors.

### BACKGROUND

Many buildings employ mechanical HVAC systems to maintain comfortable environments. These mechanical HVAC systems are used to efficiently bear heating or cooling loads for these buildings. Traditionally, HVAC systems have relied on a combination of moment to moment measurement of the load and ad hoc administrative control to ensure the correct number of equipment (e.g., chillers, boilers, pumps or fans) are in operation to handle building loads at any given time.

Equipment scheduling is an important part of running a mechanical HVAC system. Some methods require the generation of a ‘plan of the day’—a scheduling of equipment for the current day. This requires a knowledgeable engineer who understands local building conditions including the expected moment to moment building load, tenant occupation and weather.

There are considerable overhead costs incurred when equipment is turned on or off. For example, a miss-scheduled chiller (turned on too late or too early) can lead to a decrease in overall system efficiency, and increase the energy use of the HVAC system. Additionally, chillers operate in a constrained environment, having both minimum and maximum load constraints, this may cause them to become unstable and surge or stall, adding further instability to the mechanical HVAC system.

Current scheduling methods, which combine the understanding of knowledgeable engineers with dynamic system measurement, are not necessarily the most efficient nor automated. An automated method for load prediction may increase engineering resource efficiency and the efficiency of the mechanical HVAC system.

### BRIEF SUMMARY OF THE INVENTION

The present invention includes methods for determining a predicted building heating or cooling load for a future time using historical data points recorded in situ to build analytical models that use predictions of environmental conditions to provide building administrators and systems with an automated prediction of building load over a period of time. In one embodiment, the present invention allows for the automatic creation of a plan of the day by dynamically providing local building systems with a prediction of load from moment to moment that can then be used to make maximally efficient HVAC equipment operation choices. Additionally, this invention provides a method to predict and model building energy usage using a K-nearest neighbors analytical model or a linear regression model.

In one aspect of the present invention, a method, using a computer, for predicting a building load for a cooling or heating system includes the steps of (1) obtaining a plurality of inputs including historical data points and predicted data points; (2) transmitting the historical data points to a predictive load model; (3) within the predictive load model, associating the historical data inputs with a predicted load value, wherein the predictive load value is determined using a K-nearest neighbors analytical model; (4) transmitting the predictive load value to a load prediction generator; (5) transmitting a plurality of prediction data points to the load prediction generator; (6) determining a predicted building load over a future time period under consideration; and (7) determining a predicted building load for each prediction data points.

In another aspect of the present invention, a method, using a computer, for predicting a building load for a cooling or heating system includes the steps of (1) obtaining a plurality of inputs including historical data points and predicted data points; (2) transmitting the historical data points to a predictive load model; (3) within the predictive load model, associating the historical data inputs with a predicted load value, wherein the predictive load value is determined using a linear regression analytical model; (4) transmitting the predictive load value to a load prediction generator; (5) transmitting a plurality of prediction data points to the load prediction generator; (6) determining a predicted building load over a future time period under consideration; and (7) determining a predicted building load for each prediction data points.

### BRIEF DESCRIPTION OF THE DRAWINGS

Preferred and alternative embodiments of the present invention are described in detail below with reference to the following drawings:

FIG. 1 is a schematic system diagram showing a computing system usable to carry out various actions or methods according to an embodiment of the present invention;

FIG. 2 is flow diagram for determining a predicted building load over a future period of time according to an embodiment of the present invention;

FIG. 3 is a flow diagram for determining a predicted building load using a K-nearest neighbors method according to an embodiment of the present invention;

FIG. 4 is a flow diagram for determining a predicted building load using a linear regression method according to an embodiment of the present invention; and

FIG. 5 is a flow diagram for determining a predicted building load using a previous time series method according to an embodiment of the present invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with HVAC systems; automation systems (e.g., building automation systems referred to as BASs); air handler units (AHUs) such as, but not limited to terminal units (also called fan coil units), packaged units or rooftop units, and various equipment used in HVAC systems such as, but not limited to, controllable valves, heating and cooling coils, various types of sensors; controllers and processors; communication networks; various computing and/or processing systems; chillers, fans, various HVAC system equipment operational parameters and set points, data points or data points; and methods of operating any of the above with respect to one or more buildings have not necessarily been shown or described in detail to avoid unnecessarily obscuring descriptions of the embodiments of the invention.

Load prediction of mechanical HVAC systems, for example predicting future energy usage in a chiller plant, requires an understanding of chiller energy efficiency and a prediction of building load, since the first order approximation of energy usage in a chiller plant is often (chiller efficiency) multiplied by (Building Load). This means that understanding and predicting building load is an important part of both scheduling chillers for use and predicting future energy usage of the HVAC system.

Predicting building loads may advantageously permit the automatic creation of efficient equipment usage schedules and provide the ability to predict future building energy usage. The advantage further allows more flexibility for the building owner or administrator to buy energy (electricity, cold water, hot water, steam or natural gas) for their building on the energy wholesale market, which reduces costs and provides the utility companies with better insight about energy demands for the grid in the near future. In one embodiment, the load prediction (i.e., expected load for the day) may be supplied to the utility company, and when combined with a demand response program, would allow the utility company to assess the amount of energy available for a demand response event.

Predicting building loads may also advantageously permit the building owners or administrators to schedule equipment maintenance when they know the building load will be low, which in turn permits some of the equipment to be taken offline or taken out of service for maintenance.

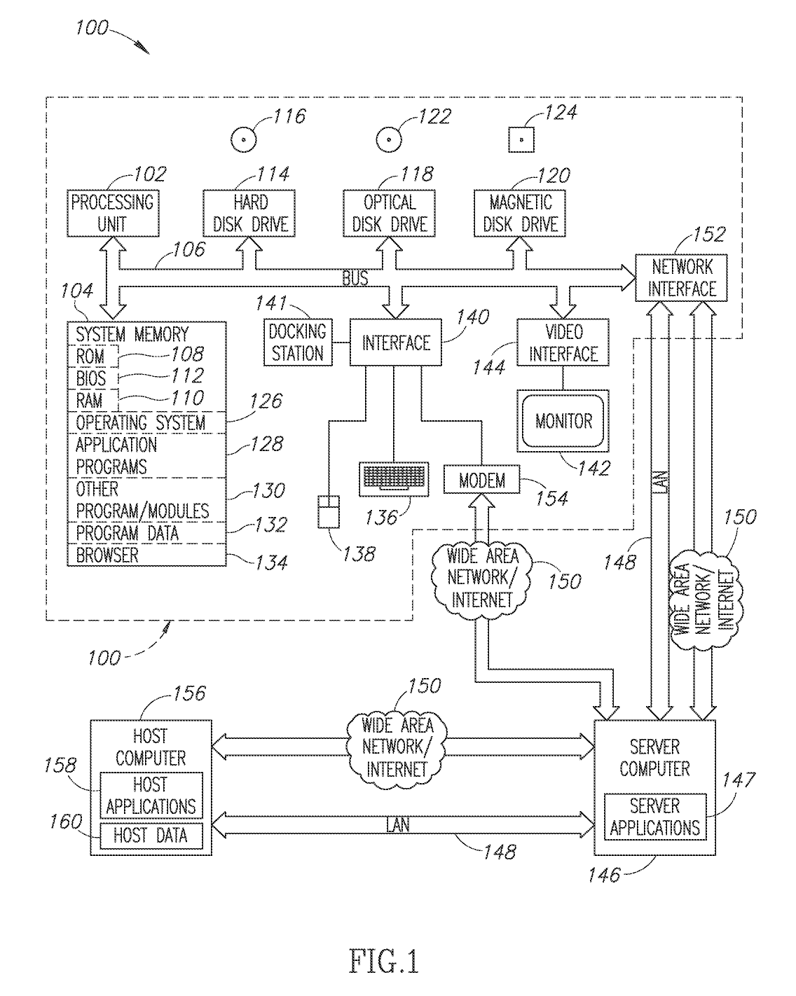

FIG. 1 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The application programs 128, program or modules 130, and program data 132 may include information regarding various HVAC equipment and sensors. The system memory 104 may also include a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 100 as a personal computer, in other embodiments, the computer is some other computer-related device such as a tablet, a television, a personal data assistant (PDA), a cell phone (or other mobile devices).

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. Another interface device that may be coupled to the bus 106 is a docking station 141 configured to receivably and electronically engage a digital pen or stylus for the purpose of data transmission, charging, etc. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

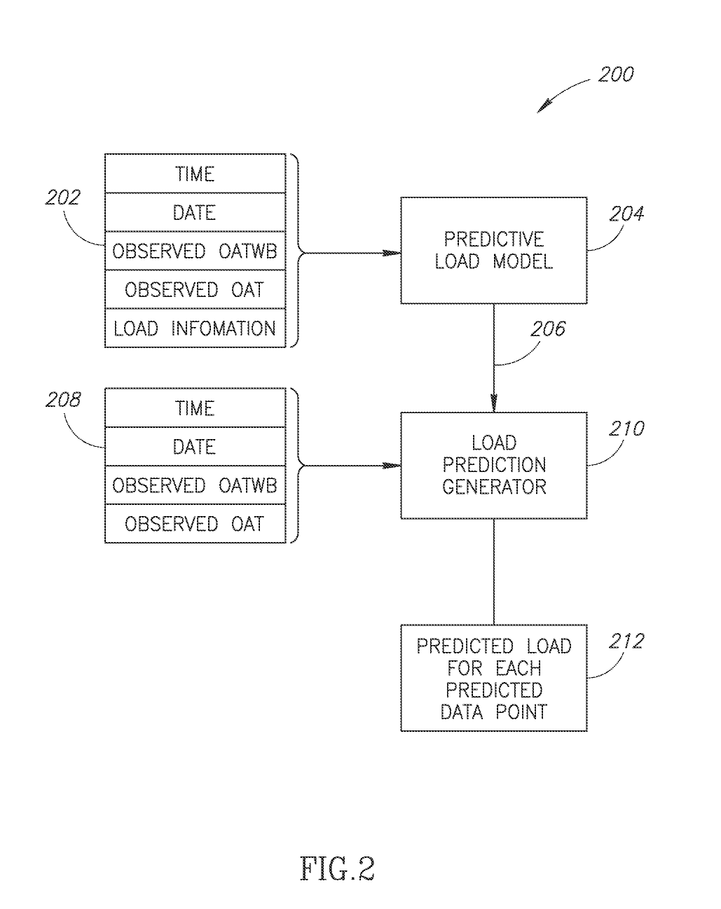

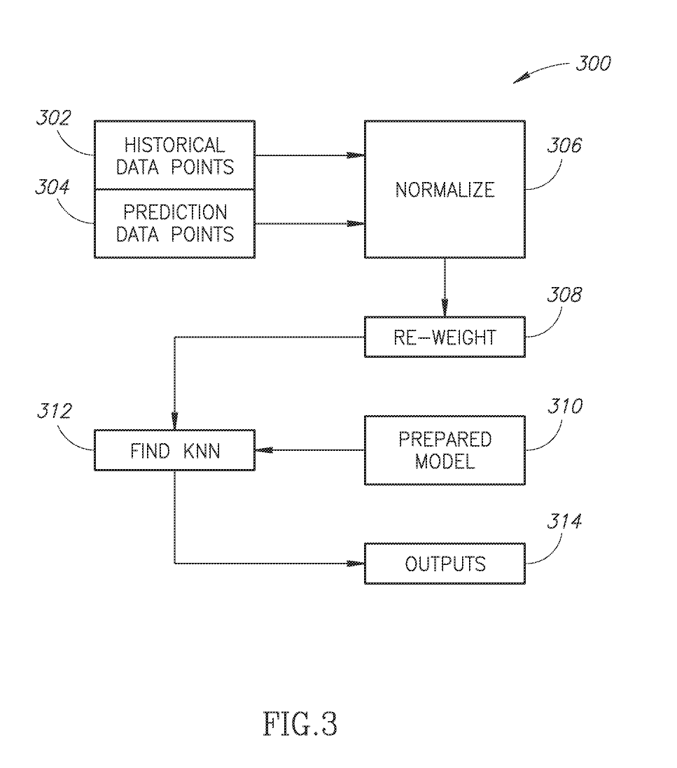

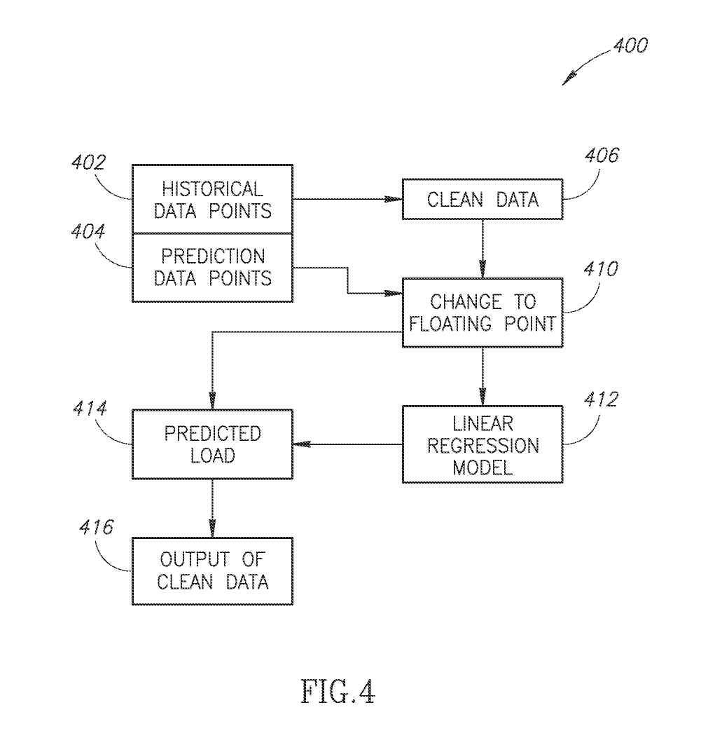

FIG. 2 shows a block diagram of a method 200 for predicting a load for a building or for a plurality of buildings within a complex. A first set of inputs 202 are provided to a predictive load model 204. The first set of inputs 202 take the form of historical data points that have been observed and/or recorded at a previous time or times. The historical data points are used to construct the predictive load model, which may take the form of a K-nearest neighbors (KNN) model, a linear regression model, or a previous time series model. The KNN and linear regression predictive load models will be described in greater detail below with respect to FIGS. 3 and 4.

The first set of inputs 202 (e.g., the historical data points) take the form of a time when each data point was observed, a date and/or day of when each data point was observed, a recorded outside air temperature-wet bulb (OATWB) for each data point, a recorded outside air temperature-dry bulb (OATDB) for each data point, and a recorded load information observed for each data point. The time may be in the form of a universal time code (UTC) time stamp, or a record of the time in minutes and hours. The time is recorded to capture the periodic thermal dynamics of a chiller plant and its attached building(s). Similarly, the date provides information as to whether the data points were collected on a weekend or a weekday, a holiday, or some other day that may have a particular significance. The time is recorded to capture the load dependency information pertaining to the work schedule of the chiller plant and its attached building(s). The OATWB is the wet bulb air temperature at the moment the data point was recorded. The OATDB is the dry bulb air temperature at the moment the data point was recorded. Lastly, the load information provides the demand load handled by the building's chiller system or systems at the moment the data point was recorded. The load information is used by the predictive load model 204 to bind the aforementioned inputs to a specific, predicted load value 206 output from the model 204.

At Step 210, a load prediction generator 210 receives the predicted load value 206 and also receives a plurality of predicted data points 208. In one embodiment, the predicted data points 208 take the form of dimension values contained in the historical data points 202 over a future time period under consideration by the predictive load model 204. The predicted data points 208 may be used, along with the predictive load model 204, to aid in the prediction of building load over a future time frame. The predicted data points 208 may include, but are not limited to, time, date, wet bulb temperature and dry bulb temperature. By way of example, the time and date may take the form of time and date stamps generated over the required prediction time frame. The wet bulb temperature may take the form of a predicted outside air temperature-wet bulb (OATWB) provided over the future time frame under consideration. The dry bulb temperature may take the form of a predicted outside air temperature-dry bulb (OATDB) over the further time frame under consideration. At Step 212, the method 200 produces a predicted load for each predicted data point

FIG. 3 shows a K-nearest neighbors (KNN) process 300 for the aforementioned predictive load model 204 (FIG. 2). The KNN process 300 accepts two time series as inputs and returns a single output time series. The KNN process 300 models a building's thermal behavior. More specifically, the KNN process 300 accepts historical and prediction data points as inputs and returns predicted loads by comparing the normalized and re-weighted data points to the original historical and prediction data points 302, 304. The KNN process 300 then finds the “K data points” that most closely resemble the original data points 302, 304. Stated otherwise, the K data points are considered representative of the original data points 302, 304.

The time series take the form of historical data points 302 and prediction data points 304 (hereinafter referred to as “data points.”), both of which were described above. The data points (Time, Date Information, etc.) come in a variety of dimensions and units. At Step 306, the data points are normalized to take the form of a ‘normal unit’, which is a unit that is statistically similar for each dimension in the data points. Next, the data points are transformed into integers and treated as random variables. Each variable's standard deviation or some multiple thereof, is determined and then each data point is divided by its standard deviation or through a set of normalization functions that relate each dimension to each other dimension. This normalization process 306 operates the same for both the historical data points and the predicted data points.

At Step 308, the data points are re-weighted such that the data points of higher importance are given a higher weight. By way of example, each dimension is stretched by a multiplying factor that makes the data points more, or less, important. Large stretching factors make the data points more important while smaller stretching factors make them less important.

At Step 310, a prepared model distributes the data points in a multidimensional space that models the behavior of the chiller plant that has been measured by the historical data points. The distribution may be used to make predictions about future, not yet observed, data points.

At Step 312 and using the prepared model 310, the K nearest neighbors for the prediction data points 304 are determined. Next, an average load of the K-nearest neighbors is calculated. At Step 314, outputs include output data points having all of the information from the prediction data points 304 and a predicted chiller plant load are provided.

FIG. 4 shows a linear regression method 400 that accepts input from historical data points 402. The model 400 is an embodiment of another technique to determine a building's thermal behavior.

The historical data points 402 may include a number of invalid points. Thus, at Step 404, the historical data points 402 are cleaned to remove any invalid data points. At Step 406, the cleaned data points are transformed into floating point numbers to allow for comparisons between different input fields.

At Step 412, a linear regression model takes the historical data points 402 and builds a linear model that relates Time, Date Information, Observed OATWB, observed OAT (e.g., the historical data points shown in FIG. 2) to the Load information (FIG. 2). In one embodiment, the linear regression model 412 operates to produce a predicted load 414, which may be computed as follows: Predicted Load 414=A*(Time)+B*(Date Information)+C*(Observed OATWB)+D*(OAT). A, B, C, and D are constants derived by the model 412 by minimizing a root square mean error over the whole linear regression model 412.

Referring back to Step 410, the predicted data points 404 are transformed into floating point numbers. Next, the values in the fields of the prediction data points 404 are used to provide the linear regression model with inputs, and a predicted load 414 is calculated directly. In the linear regression model 412, as described in the preceding paragraph, is also used to pair the each prediction data point with the predicted load 414. At Step 416, outputs are produced, and the outputs take the form of the information from the prediction data points 404 and a predicted building/campus load.

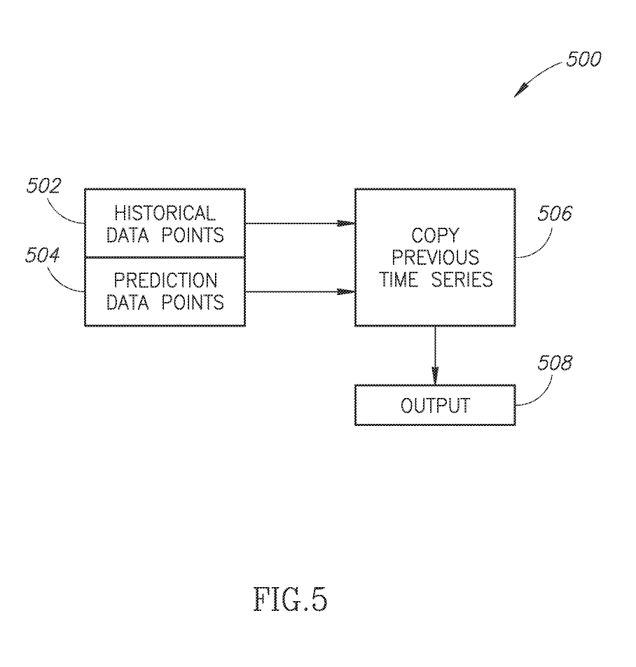

FIG. 5 is a previous time series method 500 for modeling load predictions and determining a cooling system's thermal behavior. The previous time series method 500 searches through historical data points 502 for the most recent time period that is similar to the time period under consideration. Next, the loads from that time period are copied at Step 506 and transmitted as outputs 508. This method 500 returns a historical load data time sequence, unchanged, based on a length and a timing of the prediction data points 504.

While the preferred embodiment of the invention has been illustrated and described, as noted above, many changes can be made without departing from the spirit and scope of the invention. In addition, other advantages will also be apparent to those of skill in the art with respect to any of the above-described embodiments whether viewed individually or in some combination thereof. Further, the subject matter of U.S. patent application Ser. No. 14/582,732 is incorporated herein by reference in its entirety. Accordingly, the scope of the invention is not limited by the disclosure of one or more particular embodiments. Instead, the invention should be determined entirely by reference to the claims that follow.

The embodiments of the invention in which an exclusive property or privilege is claimed are defined as follows:

1. A method, using a computer, for predicting a building load for a cooling or heating system, the method comprising:
obtaining a plurality of inputs including historical data points and predicted data points;
transmitting the historical data points to a predictive load model;
within the predictive load model, associating the historical data inputs with a predicted load value, wherein the predictive load value is determined using a K-nearest neighbors analytical model;
transmitting the predictive load value to a load prediction generator;
transmitting a plurality of prediction data points to the load prediction generator;
determining a predicted building load over a future time period under consideration; and
determining a predicted building load for each prediction data points.

2. The method of claim 1, wherein the historical data points include at least a time, a date and load information.

3. The method of claim 1, wherein historical data points were recorded or observed during a past time.

4. The method of claim 1, wherein the predicted data points include at least a time and a date of in the future.

5. The method of claim 2, wherein the load information is a demand load handled by a cooling or heating system at a moment when the load information was recorded.

6. The method of claim 1, wherein the K-nearest neighbors analytical model normalizes and re-weights the historical and prediction data points.

7. A method, using a computer, for predicting a building load for a cooling or heating system, the method comprising:
obtaining a plurality of inputs including historical data points and predicted data points;
transmitting the historical data points to a predictive load model;
within the predictive load model, associating the historical data inputs with a predicted load value, wherein the predictive load value is determined using a linear regression analytical model;
transmitting the predictive load value to a load prediction generator;
transmitting a plurality of prediction data points to the load prediction generator;
determining a predicted building load over a future time period under consideration; and
determining a predicted building load for each prediction data points.

8. The method of claim 7, wherein the historical data points include at least a time, a date and load information.

9. The method of claim 7, wherein historical data points were recorded or observed during a past time.

10. The method of claim 7, wherein the predicted data points include at least a time and a date of in the future.

11. The method of claim 8, wherein the load information is a demand load handled by a cooling or heating system at a moment when the load information was recorded.

12. The method of claim 7, wherein the linear regression analytical model cleans the historical data points.

13. The method of claim 7, wherein the linear regression analytical model changes the cleaned historical data points and the prediction data points to floating point numbers.
